(19) United States
(12) Patent Application Publication
(10) Pub. No.: US 2003/0204462 A1
(43) Pub. Date: Oct. 30, 2003

(54) Method and system for administering the hedging of an employee deferred compensation plan using swaps and options

(76) Inventor: Clifford R. Eisler, Woodbury, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 10/136,868

(22) Filed: Apr. 30, 2002

(51) Int. Cl. G06F 17/60

(52) U.S. Cl. 705/36

(57) ABSTRACT

A method and system for administering an employee deferred compensation plan, e.g., which employs hedging of liabilities using total return swaps and/or put and call options. A plan coordinator coordinates a transfer of information between an employer/plan sponsor, a plan administrator that communicates with the employees/plan participants, and swap/option providers. The plan coordinator receives and reconciles data and then calculates relevant information for use in reports that are provided to the plan sponsor and swap/option provider. The reports include an upcoming transactions report, which indicates new compensation deferrals, reallocations of previously deferred compensation among reference investment finds, and withdrawals. Moreover, a swap details report and a put and call option details report may be provided which indicates future payments that the swap/options provider must pay the plan sponsor under the swap and/or options.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention provides a method and system for administering an employee deferred compensation plan, such as one which employs hedging of liabilities using total return swaps and options.

Nonqualified deferred compensation (NQDC) plans have become increasingly popular since they allow employers to provide additional compensation to selected employees in an advantageous manner. In fact, an estimated 85% of the Fortune 1000 companies use such plans to compensate their executives. Smaller companies as well have realized the benefits of such plans. Under a NQDC plan, the income tax on the compensation is not immediately realized by the employee when it is awarded. For the employee's part, the compensation is not taxed until it is actually withdrawn, which may be several years after it is awarded. For the employer's part, although the compensation is not tax deductible until it is realized by the employee, the employer avoids the need to immediately allocate funds to compensate the employee, and the employee gains no property right in the deferred compensation and earnings until they are realized.

In fact, the NQDC plan must not be formally funded to avoid a constructive receipt of the compensation by the employee. The plan appears as an expense on the employer's income statement and creates an increasing liability on its balance sheet until benefits are paid. The eventual payment of the benefits may result in a problematic cash flow drain, and the employer can choose to finance its NQDC plan, typically using taxable investments or corporate-owned life insurance. By financing its plan, the employer is attempting to essentially hedge its eventual liability to the employees in the plan.

Moreover, a further approach for hedging liabilities in a deferred compensation plan uses a combination of total return swaps and options. In such an approach, a swap party agrees to pay the plan sponsor, such as the employer, an amount based on a theoretical, or notional investment, in one or more designated reference funds, such as a money market fund, a fixed income fund, an equity fund, a balanced fund, an S&P 500 stock fund, and so forth. In return, the plan sponsor pays the swap provider a fee, which may be based on an interest benchmark plus a spread. The notional investment may include an initial amount as well as subsequent additional contributions which may be made periodically. For example, assume an initial notional investment of $100 is made for a period of 10 years, and is allocated to an S&P 500 reference fund. Further assume the initial amount grows to $250 at the end of the ten-year term. Then, at the end of the term, the swap party pays the employer $250-$100=$150. This payment, and the respective notional swap amounts, can be settled and re-set at specified intervals. On an after tax basis, assuming a 40% tax rate, $60 grows to $150, e.g., $60 +$150×0.6 =$150. Note that the employer is still liable to the employee for $250, even though it has received only $150 from the swap provider. The employer must obtain the additional $100 from its own resources. The swap party is willing to enter into the agreement since it knows it can at least obtain funds at the benchmark interest rate and invest them in the specified reference funds. The swap party is then guaranteed a profit due to the spread. The swap party may even feel it is clever enough to obtain a higher return than the reference fund or funds and invest its funds accordingly. The plan sponsor makes periodic payments, e.g., quarterly, to the swap party based on the current notional principal amount and the sum of the benchmark interest rate and the spread. For example, assuming the applied rate is 7% and the notional principal amount is $100, the plan sponsor will make a quarterly payment (usually calculated utilizing an actual/360 basis) of $100×0.07/4=$1.75. The payment will increase accordingly when a spread such as 1.0% is added to LIBOR.

### SUMMARY OF THE INVENTION

The present invention provides a method and system for administering an employee deferred compensation plan, such as one which employs hedging of liabilities using a combination of total return swaps and options, or swaps alone.

In particular, the present invention provides a solution for the administration of such hedging plans. The invention accounts for the fact that the plans may cover many different employees whose allocation of deferred compensation over various reference funds can constantly change due to new allocations, reallocations and withdrawals. Moreover, the invention provides a flow of information between parties that may otherwise be hampered due to industry regulations, in-place business models, shareholder concerns, and other constraints. The invention facilitates the coordination and sharing of information between the plan sponsor or employer, plan administrator, which may be an outside financial services organization retained by the plan sponsor, and the swap provider, which is typically a further independent party. Furthermore, information is organized in reports for use by the plan sponsor and swap provider, and to verify the accuracy of swap details that the swap provider is using. Moreover, the invention enables a plan sponsor to match up its obligations under the plan with its swap hedges and assess its net risk. In particular, the invention provides important information to an employer, such as net position, profit and loss, and tax consequences.

In a particular embodiment, the invention provides a method for facilitating the administration of an employee deferred compensation plan. The method includes the step of providing a plan coordinator to: (a) receive plan participant information, including upcoming transactions, from a plan administrator, (b) receive and reconcile swap and option details from at least one swap and option provider, (c) provide a transaction report based on the upcoming transactions, to the at least one swap and option provider, and (d) provide summary position, accounting and tax reporting to at least one plan sponsor. The sponsor of the plan enters into a hedging agreement with the swap and option provider to hedge liabilities associated with the plan.

The reports integrate, or bring together, various information that is useful to the different parties. For example, the reports can inform the plan sponsor/employer of any differences between their liabilities to the employees for the deferred compensation, and the timing and cost of the execution of the swaps, e.g., due to the time of day of the purchase, since investment prices are always fluctuating. Thus, the swaps are not always perfectly matched to the employer's deferred compensation obligations. Advantageously, the present invention tracks this exposure and reports it to the plan sponsor periodically so the plan sponsor is always fully aware of its risk.

Thus, a further method for providing information regarding an employer's risk in an employee deferred compensation plan wherein the employer enters into a hedging agreement with at least one provider of swaps to hedge liabilities associated with the plan, includes maintaining records regarding differences between liabilities of the employer in deferred compensation and costs of swaps that the employer enters into with the at least one provider of swaps, and providing at least one report, based on the records, indicating a risk to the employer.

Thus, the plan sponsor can match up its obligations under the plan with its swap hedges and assess its risk, e.g., associated with its future liabilities in making payments of deferred compensation and the investment returns thereon to its employees.

Corresponding systems and computer program products are presented.

### BRIEF DESCRIPTION OF THE DRAWINGS

FIG. 1 illustrates a system for administering an employee deferred compensation plan in accordance with the present invention;

FIG. 2 illustrates a computer-implemented embodiment of a system for administering an employee deferred compensation plan in accordance with the present invention;

FIG. 3 (comprising FIGS. 3-1 and FIGS. 3-2) illustrates a sample deferred compensation plan details report prepared by a plan coordinator in accordance with the present invention;

FIG. 4 (comprising FIGS. 4-1 and FIGS. 4-2) illustrates a sample transaction log details report prepared by a plan coordinator in accordance with the present invention;

FIG. 5 illustrates a sample termination event details report prepared by a plan coordinator in accordance with the present invention;

FIG. 6 illustrates a sample swap details report prepared by a plan coordinator in accordance with the present invention;

FIG. 7 illustrates a sample call and put option details report prepared by a plan coordinator in accordance with the present invention;

FIG. 8 illustrates a sample accounting report prepared by a plan coordinator in accordance with the present invention; and

FIG. 9 illustrates a sample tax report prepared by a plan coordinator in accordance with the present invention.

### DETAILED DESCRIPTION OF PREFERRED EMBODIMENTS

The present invention provides a method and system for administering an employee deferred compensation plan, such as one which employs hedging of liabilities using a combination of total return swaps and/or options.

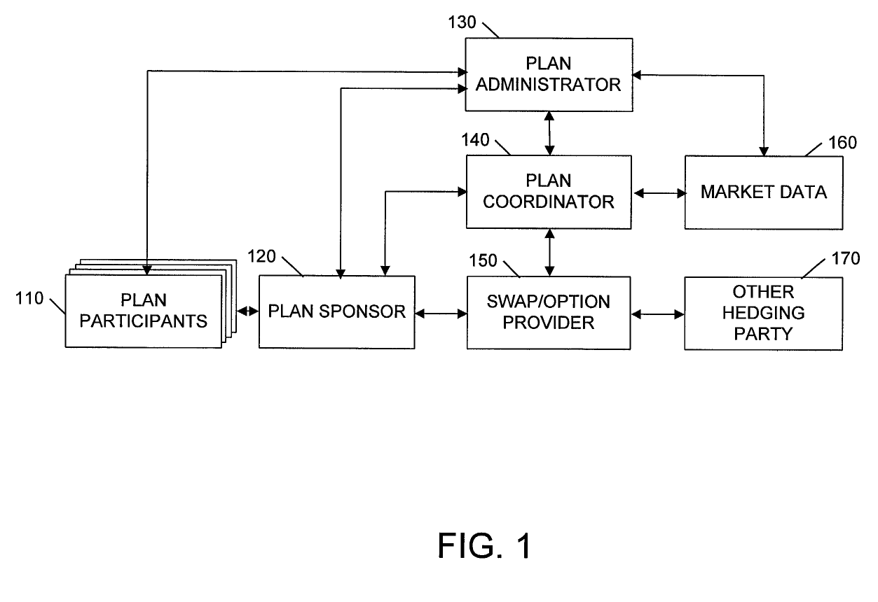

FIG. 1 illustrates a system for administering an employee deferred compensation plan in accordance with the present invention. A number of plan participants 110 may be current or former employees who have been awarded deferred compensation by an employer, or plan sponsor 120. The compensation is awarded under a deferred employee compensation plan such as those discussed above. The plan sponsor 120 (e.g., employer) typically retains a plan administrator 130, such as a financial services organization, to handle the administration of the plan, or the plan administrator 130 may be part of the plan sponsor 120. To this end, the plan administrator 130, along with the plan sponsor 120, communicate with the plan participants 110 to inform them of details of their deferred compensation awards, such as amounts and dates on which the funds may be withdrawn. The plan administrator 130 may also explain to the plan participants 110 various choices they may have regarding reference funds that may be selected for investing the deferred compensation, such as a money market fund, a balanced stock fund, an S&P 500 stock fund, and so forth. These choices are normally similar to those offered participants in their 401(k) plan, for example. The deferred compensation is only invested notionally, but the employee/participant gains the benefit of an actual investment in the selected reference funds. The compensation may be allocated among one or more of the reference funds based on the participant's instructions. Moreover, the compensation may be reallocated to different reference funds at specified times, such as once every three months. Various conditions may further be applied regarding when existing funds can be reallocated, when new funds can be allocated (e.g., due to new deferred compensation awards), or when funds may be withdrawn. The plan administrator 130 may also impose an instruction date by which the plan participants 110 must provide their instructions, e.g., for allocations, reallocations, and withdrawals. For example, a two-week lead time may be enforced to provide time to implement the instructions. The plan administrator 130 may communicate with the plan participants in various ways, such as by mail, or via an electronic means such as a telephone interface or web site.

Moreover, the plan administrator 130 may obtain valuations that are ascribed to the reference fund investments that are selected by the employees, e.g., from market data source 160, such as a real-time stock/fund ticker or the like.

A plan coordinator 140 communicates with the plan administrator 130 to receive and reconcile information such as outstanding employee balances and upcoming transactions of the plan participants 110. The reconciling may involve reviewing the information to ensure it is consistent with previous records. The plan coordinator 140 also will communicate with the swap/option provider 150, which has entered into a total return swap agreement with the plan sponsor 120. As mentioned, such hedging agreements allow the employer to reduce the risks associated with its future liabilities in making payments of deferred compensation and the investment returns thereon to its employees. Note that one or multiple swap providers may be used for hedging different portions of a deferred compensation plan. Moreover, the swap/option provider itself 150 may enter into further transactions or agreements with other parties 170 to hedge its liabilities. The plan coordinator may communicate with a market data function 160 to obtain data, e.g., regarding the current valuation of reference funds.

The swap/option provider 150 generally will maintain its own records regarding the terms of the swap agreement, but does not have access to the information of the plan participants 110, such as upcoming transactions. The upcoming transactions, such as new allocations of deferred compensation to reference funds, reallocations from one fund to another, and withdrawals represent changes in risk to the plan sponsor 120. Accordingly, the plan sponsor 120 is looking to have its swap agreement modified to reflect these changing exposures and the swap/option provider 150 uses the upcoming transaction information provided to it by the plan coordinator 140 to adjust its positions in the reference funds, other funds that generally track the reference funds, or other hedging vehicles and then updates the swap agreement accordingly. Thus, the invention keeps the plan sponsor and swap/option provider apprised of all transactions on a timely basis to enable the plan sponsor to hedge its risks in the plan in an optimal manner.

The plan coordinator 140 also receives and reconciles swap details from the swap/option provider 150. For example, the plan coordinator 140 may confirm the notional principal amounts and reference fund valuations, e.g., via market data function 160. The plan coordinator 140 may also confirm information relating to an interest benchmark used for the swap, such as the London Interbank Offered Rate (LIBOR), including reset dates, current rate, spread, accrual basis, and next payment amount due the swap/option provider 150 by the plan sponsor 120. As discussed in further detail below, the plan coordinator 140 may provide this and other information in the form of reports to the plan administrator 130, swap/option provider 150, and plan sponsor 120.

Moreover, the plan coordinator 140 maintains records to keep track of the plan sponsor's net risk or exposure based on differences between its liabilities to the participants due to the deferred compensation and investment gains, and the swap costs.

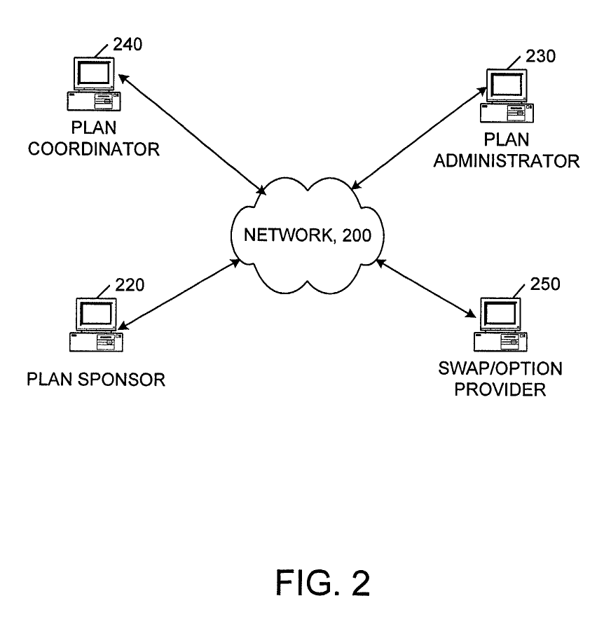

FIG. 2 illustrates a computer-implemented embodiment of a system for administering an employee deferred compensation plan in accordance with the present invention. The processes performed by the plan coordinator 240 and other parties may be computer-implemented using known computer and networking techniques. For example, the system may include individual computer workstations that are used by the involved parties, including plan coordinator computer 240, plan administrator computer 230, swap/option provider computer 250, and plan sponsor computer 220. Moreover, these computers may communicate via a network 200, which may include the Internet, dial up links, or a private network, for example.

The computers may be personal computers, network terminals, workstations, or other general purpose computers. As such, they each include a CPU, such as any commercially available central processing unit (e.g., Intel Pentium III, Motorola, etc.); volatile and nonvolatile memory devices such as RAM, ROM, and magnetic or optical discs; input devices such as a keyboard, mouse, touch screen, or electronic stylus; output devices such as CRTs, monitors, or printers; communication interface hardware such as a modem, fax/modem, or network card; and software including operating system software, user interface software, and applications such as spreadsheets, word processors, and clients for email and other messaging systems. The computers may contain and execute software to perform the various calculations, communications, report generation, and database functions as described herein. Moreover, the software may be stored on a computer program product such as a disk, where the software is loaded into the memory of the computer to enable it to be executed and carry out the desired functions as disclosed herein. The memory devices may also store a database, e.g., commercial databases such as DB2/2 for OS/2, Microsoft Access for Windows, and Oracle's SQL server, for storing information needed to support and administer the system as described herein.

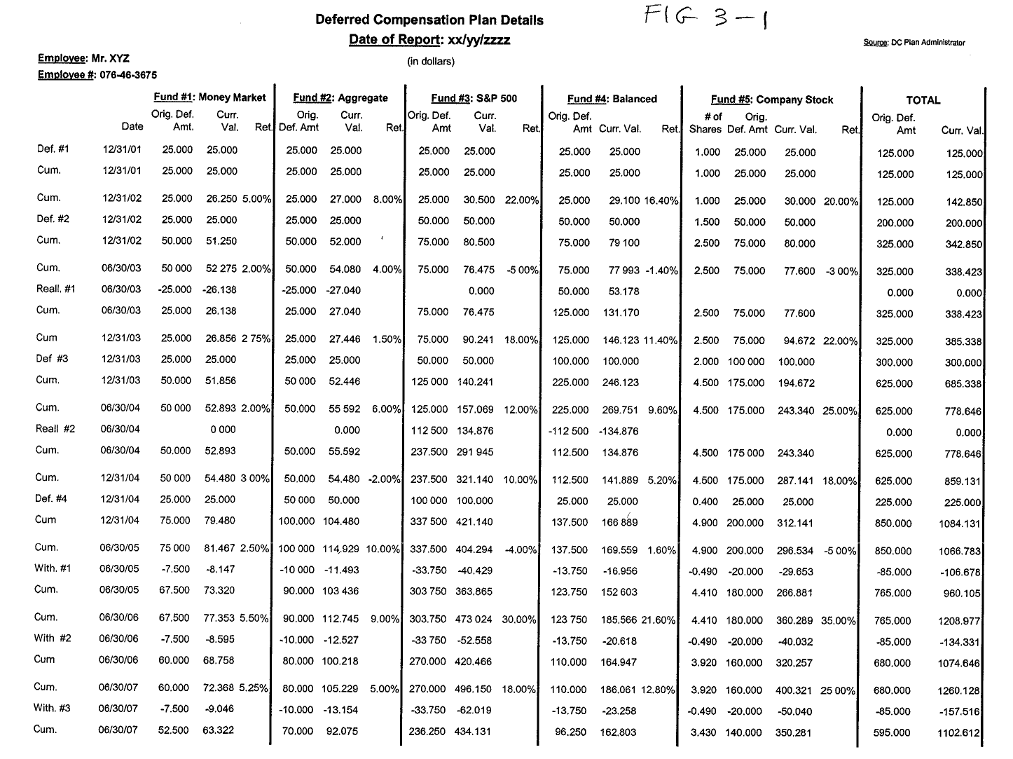

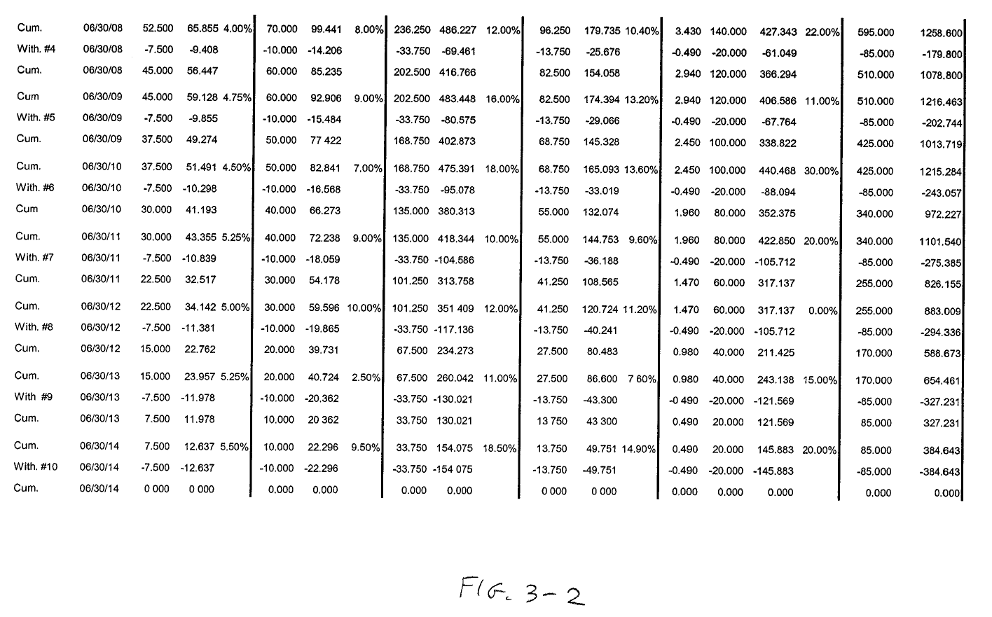

FIG. 3 (comprising FIGS. 3-1 and FIGS. 3-2) illustrates a deferred compensation plan details report prepared by a plan coordinator in accordance with the present invention. This report may be generated and summarized by the plan coordinator 140 periodically, such as monthly. The report is generated using information provided by the plan administrator 130, and indicates the original deferred compensation amounts, current deferred valuations and the specified index returns for a given plan participant. This information is presented for each reference fund, or deferral option, in which the deferred compensation is allocated (e.g., money market, Lehman aggregate, S&P 500, balanced fund, and company stock). The total original deferred amounts are also the anticipated initial notional swap amounts. Note that the swap agreement may be considered to be comprised of individual mini-swaps for each new compensation deferral. Additionally, events such as deferrals, reallocations, and withdrawals, and corresponding dates, are listed chronologically. These plan sponsor deferred compensation plan obligations will subsequently be summarized and matched with the actual swap details and the net exposure will be reported by the plan coordinator 140 to the plan sponsor 120.

As an example, a first compensation deferral (“def. #1”), or award of deferred compensation, occurs on Dec. 31, 2001. The total non-company stock deferral amount, which is also the anticipated original swap notional amount, is $100.00, as seen in the right hand column (less the company stock). This total amount is allocated among the five deferral options, or references funds, at $25.00 each. On Dec. 31, 2002, a cumulative amount of the deferral is equal to the original amount plus investment gains. For example, for fund #1, the deferral amount increased from $25.00 to $26.25, for a specified index return of 5.00%. Note that the different funds experience difference investment returns. The total deferral amount increases from $125.00 to $142.85. Also on this date, a second compensation deferral for $200.00 is made, and again allocated among the five reference funds, with $25 to each of funds #1 and #2, and $50.00 each to funds #3, #4 and #5. Note that the term “fund” is used generally to refer to any investment option, and not necessarily only to a mutual fund. With this deferral, the deferral amount for fund #1 reaches $26.25 +$25.00=$51.25. The total deferral amount reaches $142.85+$200.00=$342.85. The original deferred amount for fund #1 reaches $50.00 ($25.00+$25.00) and the total original deferred amount reaches $325.00 ($125.00+$200.00).

On Jun. 30, 2003, the deferral amount for fund #1 increases from $51.25 to $52.275, for a specified index return of 2.00%. The total current deferral amount decreases slightly from $342.85 to $338.423 due to losses in funds #3, #4 and #5. This amount is essentially formed by a weighted average of the component funds. Also on this date, a reallocation #1 (“reall. #1”) is requested by the plan participant to shift $25.00 from each of funds #1 and #2 to fund #4. Thus a debit of $25.00 is entered for each of funds #1 and #2, and a credit of $50.00 is entered for fund #4.

On Dec. 31, 2003, a deferral #3 is made for a total of $300.00. On Jun. 30, 2004, $112.50 is reallocated from fund #4 to fund #3. On Dec. 31, 2004, a further deferral #4 is made for a total of $225.00. Just after this date, it is assumed that the employee retires and starts withdrawing funds over a ten-year pay out period. Withdrawals #1 through #10 (“With.”=withdrawal) are made on Jun. 30, 2005 through Jun. 30, 2014, respectively. Each withdrawal is based on the same original deferred amount, e.g., $85.00 (obtained by dividing the original deferral amount of $850.00 on Jun. 30, 2005 by the ten-year pay out period), but the actual withdrawal amount is based on the current valuation of the deferrals. For example, on Jun. 30, 2005, the original deferral amount of $85.00 translates to an actual withdrawal amount of $106.678 based on the ratio of the current value of the deferral options $1066.783 to the original deferral amount $850. That is, ($1066.783/$850)×$85.00=$106.678. After the withdrawal #1, the remaining original deferral amount is $765.00, and the current valuation of deferral options is $960.105. One year later, on Jun. 30, 2006, the original deferral amount is still $765.00. However, the current valuation of deferral options has increased from $960.105 to $1,208.977 due to the investment returns. The withdrawal #2 amount is therefore ($1,208.977/$765.00)×$85.00 =$134.331. The withdrawal process continues with the subsequent withdrawals until a zero balance is reached for both the remaining original deferral amount and the current valuation of deferral options on Jun. 30, 2014.

Alternatively, the plan participant may elect to receive a lump sum distribution of deferred compensation.

Moreover, note that the report of FIG. 3 is provided for the details of a particular employee. However, these details may be obtained from a number of different swap agreements. Advantageously, by providing employer- and employee-specific reports, the employer can readily understand its obligations under the different swaps, and how the obligations are attributed to each employee individually.

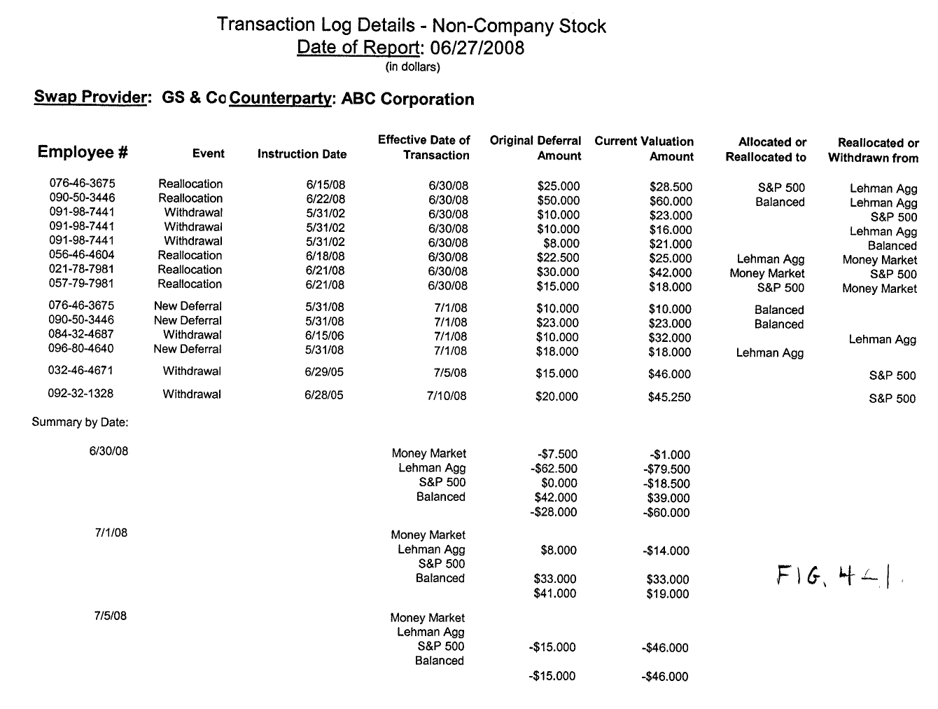

FIG. 4 (comprising FIGS. 4-1 and FIGS. 4-2) illustrates a transaction log details report prepared by a plan coordinator 140 in accordance with the present invention. This report may be generated by the plan coordinator 140 periodically, such as every day, to show the upcoming transactions for a given period of time, such as the next two weeks. The report is generated using information provided by the plan administrator 130, and indicates events such as new deferrals (new deferred compensation), withdrawals, and reallocations. Note that the required lead times and timing of new deferrals and withdrawals will generally be set by the plan sponsor, while the plan participant may provide instructions for reallocating the compensation among the various investment offerings from time to time via the plan administrator. The report indicates the employee, the event, the date the instruction was provided, the effective date of the transaction, the original deferral amount and current valuation associated with the event, the reference fund into which a allocation/new deferral is to be sent, and a reference fund from which a reallocation or withdrawal is to be withdrawn. For a new deferral, the original deferral amount and current valuation amount are the same since no investment gains (or losses) have been experienced. Moreover, the swap provider and counterparty (e.g., plan sponsor/employer) are also indicated.

The report further provides a summary of increases and decreases to the various reference funds based on the upcoming transaction date. Information may also be provided regarding interest payments, and settlement amounts as they relate to withdrawals and the settlement of swaps at termination. Moreover, note that separate reports of this type may be provided, where one details transactions for investment funds other than the company stock, and one details transactions for investments in the company stock. This is done since the deferred compensation that is allocated to company stock is generally handled differently than the compensation allocated to non-company stock investment options. This is true since the value of company stock can be controlled to some extent by the company, e.g., through stock buybacks and issuance of the new stock. In particular, the company stock amount may be hedged using puts and calls rather than a swap.

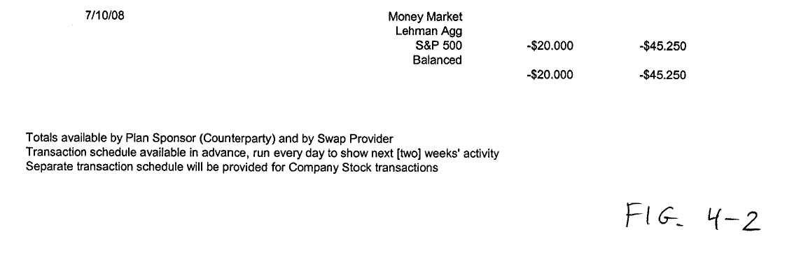

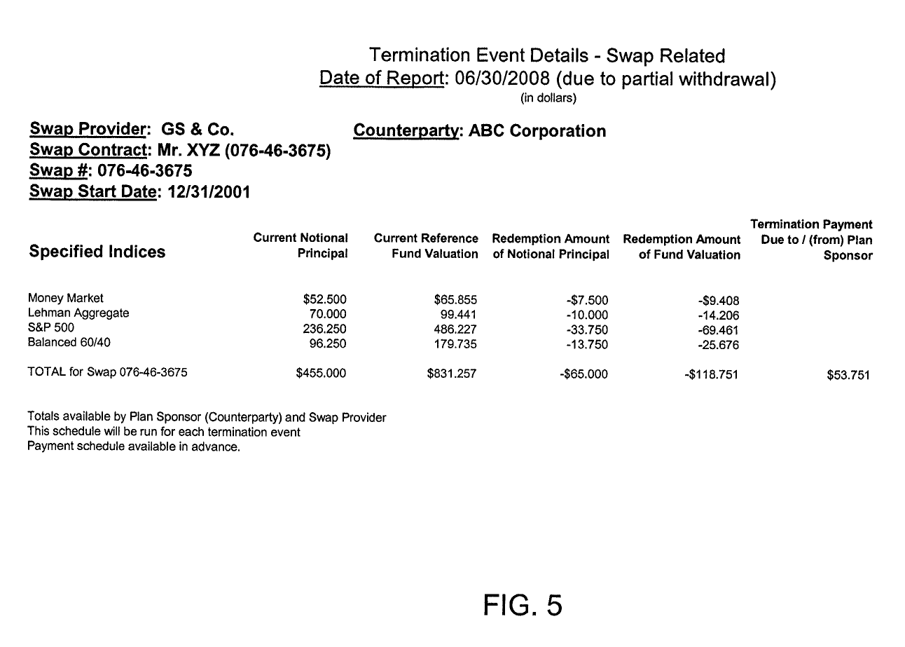

FIG. 5 illustrates a termination event details report prepared by a plan coordinator in accordance with the present invention. This report may be generated by the plan coordinator 140 for each termination event, which occurs upon a withdrawal or other specified swap reset or termination event. Each deferred compensation amount that is allocated is hedged by a separate swap agreement with a given term. For example, here the swap start date is Dec. 31, 2001, and the swap number is 076-46-3675. Note that the plan coordinator keeps track of the different swaps/options and the associated plan sponsor and swap provider(s). Generally, the plan coordinator may provides its services to a number of different plan sponsors and swap/options providers. The plan coordinator may organize its records using known database techniques to keep track of the swaps that are associated with a given party.

The swap provider pays the plan sponsor an amount based on the investment gains attributable to the original deferred amount. If there is a loss, the plan sponsor pays the amount of the loss to the swap provider. Each swap can terminate on its expiration date, or at an earlier time, e.g., due to a withdrawal. The report will be provided to the swap/option provider 150 and the plan sponsor 120. Moreover, the report is generated for each plan participant involved in a termination event. For example, here, the designated participant has made a withdrawal of $65.00 of notional principal, which corresponds to a redemption amount based on the fund valuation of $118.751. This amount is obtained by multiplying $65.00 by the ratio of the current reference fund valuation of $831.257 to the current notional principal of $455.00. Under the swap agreement, the swap provider pays the plan sponsor, or counter party, the gain experienced by the original principal amount, or $118.751-$65.00=$53.751. This is the termination payment.

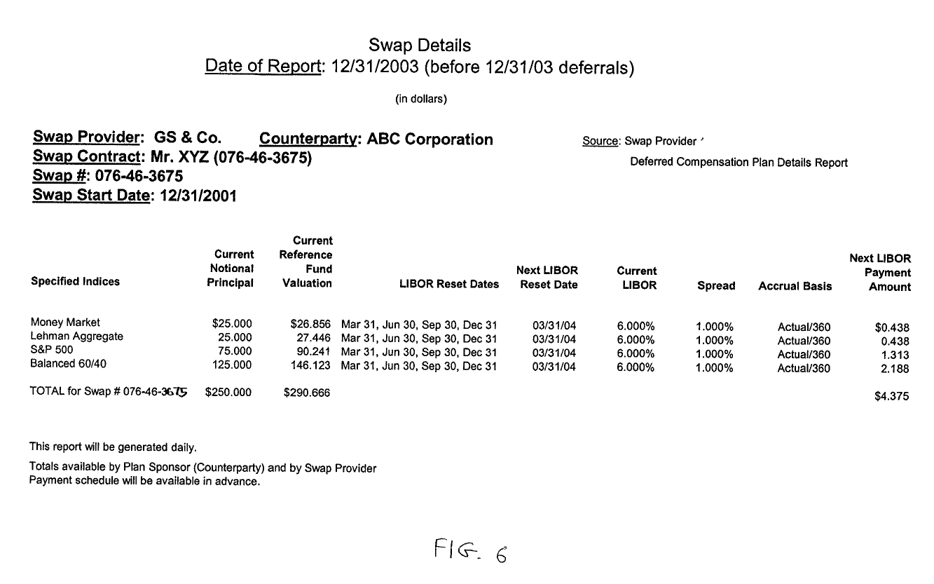

FIG. 6 illustrates a swap details report prepared by a plan coordinator in accordance with the present invention. The swap details report provides a summary of outstanding swaps for each plan participant. This report is specific to a certain swap agreement. Also, it is noted that the swap details apply before the deferrals which are scheduled for the same date are accounted for. Advantageously, the plan coordinator 140 reconciles the information provided by the swap provider 150 to ensure it is accurate. The report may be generated daily, and indicates current notional principal and current reference fund valuation for each of the investment funds. Additionally, the report indicates future reset dates for the interest rate benchmark, such as LIBOR, on which the swaps are based, as well as the next reset date. The reset dates are dates on which a new interest rate is applied to the swap for determining the payments that the swap sponsor makes to the swap provider. The current LIBOR is also provided, e.g., 6.000%, along with the spread, e.g., 1.000%. The accrual basis, which refers to how the interest is applied, is also provided, which may be, e.g., actual/360, actual/365, or 30/360. The next LIBOR payment amount is also provided, and is determined by taking the total interest rate, which is the sum of the current LIBOR and the spread, as applied to the current notional principal. For example, assuming the payments are made every three months (quarterly), with a current notional principal of $250.00, the payment amount is 7%/year×$250.00×¼ year=$4.375. The payments would vary from this amount using the accrual basis. This payment is further broken down into the components which are allocated to each investment fund. Similarly, if the index leg of the swap resets periodically, with a cash settlement and corresponding adjustment of swap notional amounts, this will also be presented.

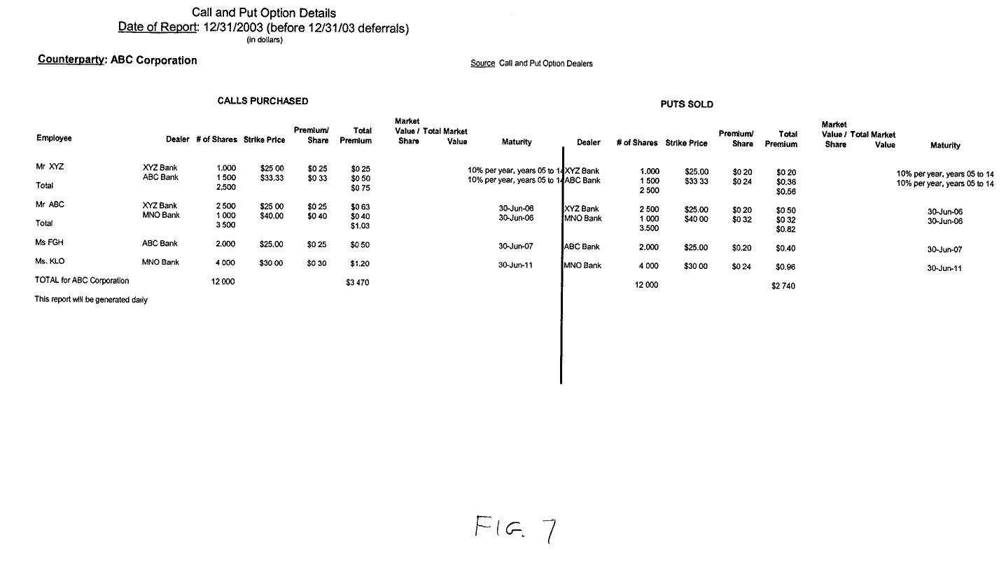

FIG. 7 illustrates a sample call and put option details report prepared by a plan coordinator in accordance with the present invention. The report provides a summary of calls purchased and puts sold for each plan participant, including details such as dealer, number of shares, strike price, premium per share, total premium, market value per share, total market value, and maturity. The report may be generated daily. This report is not related to any swap agreement, but is nevertheless provided by the plan coordinator to provide a complete picture to a plan sponsor of its liabilities in its deferred compensation plans.

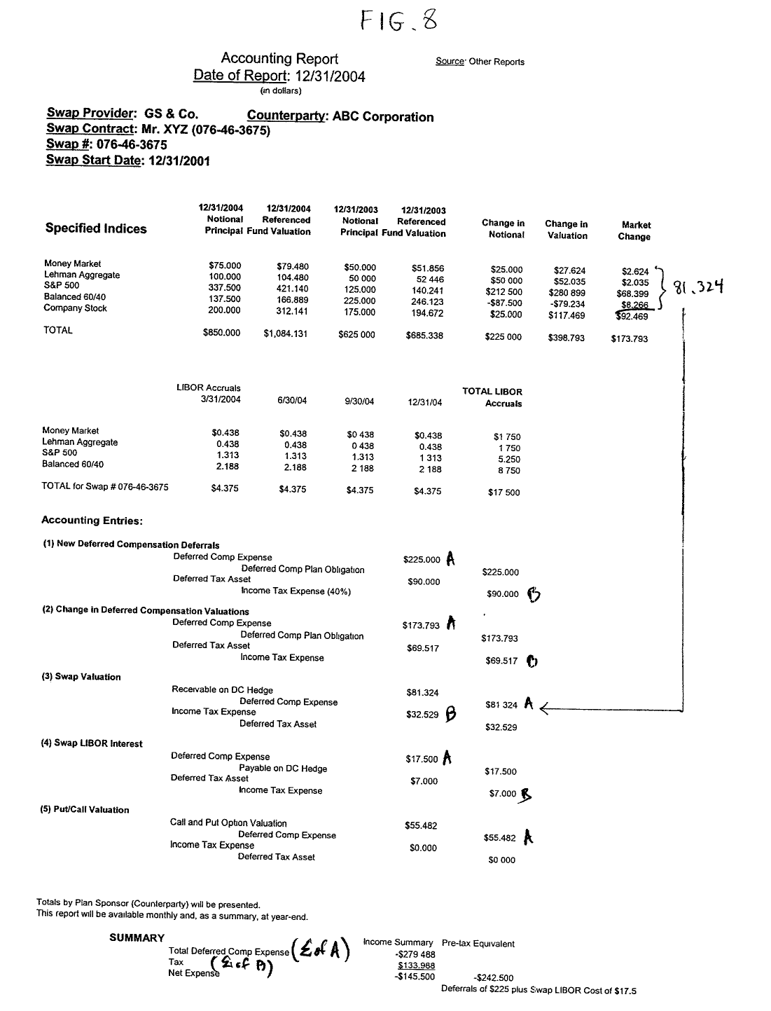

FIG. 8 illustrates an accounting report prepared by a plan coordinator in accordance with the present invention. This report may be provided, e.g., monthly, with a year-end summary, and is used by the plan sponsor. This report is specific to a given swap contract as indicated. The report indicates changes in the notional principal and reference fund valuation over a period of time, such as a year. As an example, the values on Dec. 31, 2004 and Dec. 31, 2003 are provided. The market change, which is essentially the investment return, indicates the difference between the change in the notional amount and the change in valuation. The LIBOR accruals are also provided, which are the LIBOR payment amounts. Recall FIG. 6, where the LIBOR payment amount of $4.375 for Feb. 31, 2004 is calculated.

Furthermore, the accounting report provides accounting entries for the deferred compensation and swap/option hedge balances. In particular, a deferred compensation expense of $225.00 is accounted for relative to the current period defined. This is the change in notional value over the period Dec. 31, 2003 to Dec. 31, 2004. An offsetting deferred compensation plan obligation of $225.00 is also accounted for. A deferred tax asset of $90.00 is also accounted for. This is obtained by assuming a tax rate of 40% ($90/$225).

Also, under the accounting entries, a change in deferred compensation valuations is accounted for. In particular, a deferred compensation expense of $173.793 is the market change or notional investment gain. A corresponding deferred compensation plan obligation is also accounted for. The assumed deferred tax asset and income tax expense of $69.517 is obtained by applying a 40% tax rate to $173.793. Next, a swap valuation accounting entry includes a receivable on the deferred compensation (DC) hedge, and a corresponding credit to deferred compensation expense of $81.324. This is the change in the difference between referenced fund values and notional principal on all funds except company stock. A swap LIBOR interest entry includes a deferred compensation expense and a corresponding amount payable on the DC hedge of $17.500, which is the total of LIBOR payments accrued from Jan. 1, 2004 through Dec. 31, 2004. The associated deferred tax asset and income tax expense is 40% of $17.500, or $7.000.

The accounting entries further include put and call valuation entries, including the change in the call and put option valuation and corresponding reduction in deferred compensation expense of $55.482. There is no income tax expense on the income on the puts and calls.

In a summary portion of the report of FIG. 8, the total deferred compensation expense is −$279.488 (the summation of all entries to the deferred compensation expense account, labeled “A”), and the total tax is $133.988 (the summation of all entries to the tax expense account, labeled “B”). The net expense is therefore $145.500 ($279.488−$133.988), and the pre-tax equivalent is $242.500; the deferrals of $225 plus the swap LIBOR cost of $17.50.

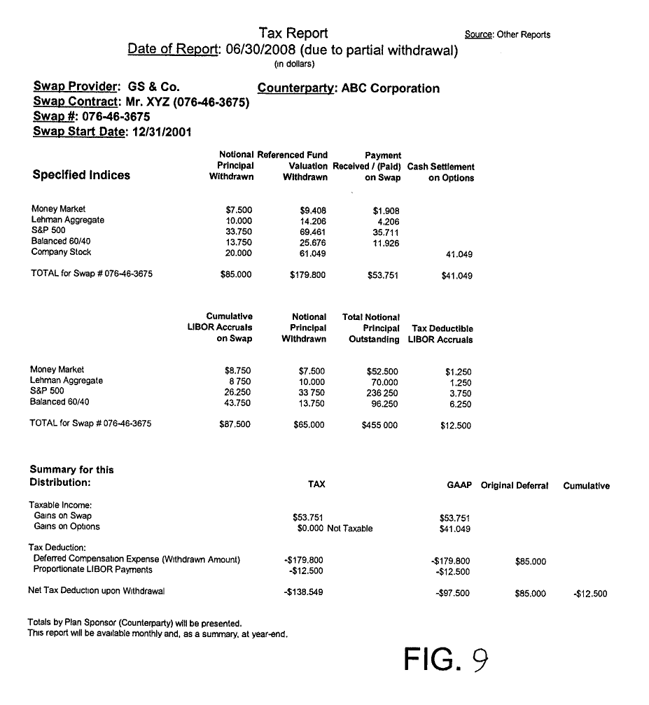

FIG. 9 illustrates a tax report prepared by a plan coordinator in accordance with the present invention. This report may be provided, e.g., monthly, with a year-end summary, and is used by the plan sponsor/employer. The report is specific to a swap contract as indicated. Here, the tax report indicates the tax consequences of a partial withdrawal. As mentioned, there is no tax liability to the participant/employee or sponsor/employer until the deferred compensation is realized by the participant, such as through a withdrawal. This type of report may also cover a full, rather than partial, withdrawal.

Assume a withdrawal is made having a total notional principal value of $85.00, and a corresponding reference fund valuation of $179.800. The payment made to the plan sponsor by the swap provider is equal to the investment growth of the reference funds over the notional principal amount for all indices except Company Stock. The payment in this case is $53.751. The cash settlement on company stock options is equal to the current value of the stock options on the company stock ($61.049) less the original principal amount ($20.000), or $41.049, and is not taxable. Here, the withdrawal uses amounts from the different reference funds, although it is also possible to withdraw funds from only a single reference fund, if desired by the plan participant. The report also indicates the accumulated LIBOR accruals on swap, notional principal withdrawn, total notional principal outstanding, and tax deductible LIBOR accruals. The tax deductible LIBOR accrual is equal to the cumulative LIBOR accruals multiplied by the proportion of the total notional principal being withdrawn.

The tax report also provides summary information for the distribution regarding the taxable income, including gains on swap and gains on options, the tax deduction including the withdrawn amount and the proportional LIBOR payments, and the net tax deduction upon withdrawal.

Accordingly, it can be seen that the present invention provides a method and system for administering an employee deferred compensation plan, such as one which employs hedging of liabilities using total return swaps and put and call options. A plan coordinator coordinates a transfer of information between an employer/plan sponsor, a plan administrator that communicates with the employees/plan participants, and swap/option providers. The plan coordinator receives and reconciles data and then calculates relevant information for use in reports that are provided to the plan sponsor and swap/option providers. The reports include an upcoming transactions report, which indicates new compensation deferrals, reallocations of previously deferred compensation among reference investment finds, and withdrawals. Moreover, a swap details report and put and call options details report may be provided which indicate future payments that the swap provider must pay the plan sponsor under the swap.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for facilitating the administration of an employee deferred compensation plan, comprising:
providing a plan coordinator to: (a) receive and reconcile plan participant information, including upcoming transactions, from a plan administrator, (b) receive and reconcile swap and option details from at least one swap and option provider, (c) provide a transaction report based on the upcoming transactions, to the at least one swap and option provider, and (d) provide summary position, accounting and tax reporting to at least one plan sponsor;
wherein the at least one plan sponsor enters into a hedging agreement with the at least one swap and option provider to hedge liabilities associated with the plan.

2. The method of claim 1, wherein:
the transaction report indicates, for each plan participant, an upcoming transaction comprising at least one of a reallocation, withdrawal and new deferral, and an effective transaction date associated therewith.

3. The method of claim 1, wherein:
the transaction report indicates at least one reference investment associated with the upcoming transactions.

4. The method of claim 1, wherein:
the transaction report indicates at least one of an original deferral amount and a current valuation amount.

5. The method of claim 1, wherein:
the plan coordinator provides, for at least one plan participant, a plan details report indicating reference funds in which deferred compensation is allocated, and an original deferral amount and a current valuation of the deferred compensation.

6. The method of claim 1, wherein:
the hedging agreement comprises at least one of a: (a) total return swaps and (b) put and/or call options.

7. The method of claim 1, wherein:
the plan coordinator provides a termination events report indicating, for a given one of the plan participants, at least one redemption from the plan.

8. The method of claim 7, wherein:
the termination events report indicates a termination payment due one of the plan sponsor and the swap and option provider.

9. The method of claim 8, wherein:
the termination payment is determined by scaling a redemption amount of notional principal by a ratio of a current notional principal to a current reference fund valuation.

10. The method of claim 9, wherein:
the redemption amount of notional principal, current notional principal, and current reference fund valuation are each weighted averages of component values thereof, wherein each component value is associated with a different reference fund.

11. The method of claim 1, wherein:
the plan coordinator provides, for at least one of the plan participants, a swap details report indicating a current notional principal amount, a current reference fund valuation, and a next swap payment amount due.

12. The method of claim 1, wherein:
the plan coordinator provides, for at least one of the plan participants, a call and/or put option details report indicating calls purchased and/or puts sold.

13. The method of claim 1, wherein:
the plan coordinator provides, for at least one of the plan participants, an accounting report integrating and indicating the deferred compensation plan obligations, swap and/or option hedges, and the net exposure and accounting results including changes in a notional principal amount and a reference fund valuation over a predetermined period.

14. The method of claim 1, wherein:
the plan coordinator provides, for at least a particular one of the plan participants, a tax report integrating and indicating the deferred compensation plan obligations, swap and/or option hedges, and the net exposure and tax results including a tax deductible payment received or paid on the hedging agreement by the plan sponsor and a tax deductible payment made to the particular participant by the plan sponsor.

15. The method of claim 1, wherein:
the plan coordinator is computer-implemented.

16. The method of claim 1, wherein:
the plan sponsor is an employer and the plan participants are current and/or former employees thereof.

17. A system for facilitating the administration of an employee deferred compensation plan, comprising:
a computer-implemented plan coordinator to: (a) receive and reconcile plan participant information, including upcoming transactions, from a plan administrator, (b) receive and reconcile swap and option details from at least one swap and option provider, (c) provide a transaction report based on the upcoming transactions, to the at least one swap and option provider, and (d) provide summary position, accounting and tax reporting to at least one plan sponsor;
wherein the at least one plan sponsor enters into a hedging agreement with the at least one swap and option provider to hedge liabilities associated with the plan.

18. A computer program product, comprising:
a computer usable medium having computer readable program code means embodied therein for facilitating the administration of an employee deferred compensation plan;
the computer readable program code means comprising means for executing instructions for implementing a plan coordinator to: (a) receive and reconcile plan participant information, including upcoming transactions, from a plan administrator, (b) receive and reconcile swap and option details from at least one swap and option provider, (c) provide a transaction report based on the upcoming transactions, to the at least one swap and option provider, and (d) provide summary position, accounting and tax reporting to at least one plan sponsor;
wherein the at least one plan sponsor enters into a hedging agreement with the at least one swap and option provider to hedge liabilities associated with the plan.

19. A method for facilitating the administration of an employee deferred compensation plan wherein at least one plan sponsor enters into a hedging agreement with at least one provider of swaps to hedge liabilities associated with the plan, comprising:
receiving and reconciling plan participant information, including upcoming transactions;
receiving and reconciling swap details from the at least one provider;
providing a transaction report based on the upcoming transactions, to the at least one provider; and
providing summary position, accounting and tax reporting to the at least one plan sponsor.

20. A system for facilitating the administration of an employee deferred compensation plan wherein at least one plan sponsor enters into a hedging agreement with at least one provider of swaps to hedge liabilities associated with the plan, comprising:
means for receiving and reconciling plan participant information, including upcoming transactions;
means for receiving and reconciling swap details from the at least one provider;
means for providing a transaction report based on the upcoming transactions, to the at least one provider; and
means for providing summary position, accounting and tax reporting to the at least one plan sponsor.

21. A method for providing information regarding an employer's risk in an employee deferred compensation plan wherein the employer enters into a hedging agreement with at least one provider of swaps to hedge liabilities associated with the plan, comprising:
maintaining records regarding differences between liabilities of the employer in deferred compensation and costs of swaps that the employer enters into with the at least one provider of swaps; and
providing at least one report, based on the records, indicating a risk to the employer.

22. A system for providing information regarding an employer's risk in an employee deferred compensation plan wherein the employer enters into a hedging agreement with at least one provider of swaps to hedge liabilities associated with the plan, comprising:
means for maintaining records regarding differences between liabilities of the employer in deferred compensation and costs of swaps that the employer enters into with the at least one provider of swaps; and
means for providing at least one report, based on the records, indicating a risk to the employer.
